(19) United States
(12) Patent Application Publication
(10) Pub. No.: US 2023/0032464 A1
(43) Pub. Date: Feb. 2, 2023

(54) COMPOSITION COMPRISING SPORES AND PRO-PERFUME MATERIALS

(71) Applicant: The Procter & Gamble Company, Cincinnati, OH (US)

(72) Inventors: Neil Joseph LANT, NEWCASTLE UPON TYNE (GB); Katherine Esther Latimer, NEWCASTLE UPON TYNE (GB); Margaux Marie Anna Defaye, LIMOGES (FR)

(21) Appl. No.: 17/829,415

(22) Filed: Jun. 1, 2022

(30) Foreign Application Priority Data
Jul. 19, 2021 (EP) 21186302.2

(51) Int. Cl. C11D 3/50; C11D 3/22; C11D 3/38

(52) U.S. Cl. CPC C11D 3/507; C11D 3/22; C11D 3/381

(57) ABSTRACT

A surface treatment composition including from about 1×10² to about 1×10⁹ CFU/g of the composition of Bacillus spores; from about 0.01% to about 15% by weight of the composition of a pro-perfume material including a glycoside, a phosphate acid ester, an amino-acid derivative, a carboxylic acid derivative, or a combination thereof; and a perfume.

### FIELD OF THE INVENTION

The present application is in the field of treatment compositions. In particular, it is directed to a treatment composition comprising bacterial spores, a pro-perfume material and a perfume. It is also related to a method of treating a surface with the composition. The composition and method can provide sustained reduction and/or prevention of malodor and at the same time long-lasting perfume release from the surfaces.

### BACKGROUND OF THE INVENTION

In many consumer products it is desirable for a fragrance to be released slowly over time. Many substantive (long-lasting) odorants are known, but a great number of odorants are too volatile to be perceived more than a few hours after their application. This is the reason why more efficient and effective fragrance-delivery system, especially for fabric and home care products, are intensely sought. Delivery systems such as micro-capsules have been developed and are already in use to help decrease volatility, to improve stability, and to enable a slow release.

Another approach consists of employing fragrance precursors or “pro-perfumes”. Fragrance precursors for scenting fabrics being washed in the presence of a lipase-containing detergent are described in WO 95/04809. The fragrance precursors are cleaved by the lipase and a single odoriferous compound, either an odoriferous alcohol, aldehyde or ketone is yielded. However, these compositions can present in-product stability. EP1077251 discloses a fabric softening composition comprising a surfactant as fabric softener active, a fragrance precursor and an enzyme suitable for cleaving the fragrance precursor, upon application in the rinsing step of a fabric. WO2016142329 discloses glucoside perfumes that can be activated by glucosidases. Still there is a need to find alternatives to pro-perfume activation to provide long lasting scent of surfaces.

There is a need for methods and compositions that provide long-lasting malodor removal and/or prevention and at the same time long-lasting perfume delivery.

### SUMMARY OF THE INVENTION

According to a first aspect, there is provided a surface treatment composition comprising Bacillus spores, a pro-perfume material and a perfume. The pro-perfume material is selected from the group consisting of glycosides, phosphate acid esters, amino-acid derivatives, carboxylic acid derivatives and mixtures thereof. Preferably, the pro-perfume material comprises a glycoside. Preferably, the pro-perfume material comprises an alkylmonoglucoside and/or an alkylpolyglucoside.

For example, a surface treatment composition can comprise: a) from about 1×10² to about 1×10⁹ CFU/g, preferably from 1×10³ to about 1×10⁷ CFU/g and more preferably from 1×10⁴ to about 1×10⁷ CFU/g of the composition of Bacillus spores; b) from about 0.01% to about 15%, preferably from about 0.01% to about 10% by weight of the composition of a pro-perfume material selected from the group consisting of glycosides, phosphate acid esters, amino-acid derivatives, carboxylic acid derivatives and mixtures thereof; and c) a perfume, preferably from about 0.001% to about 10%, more preferably from about 0.001 to about 5% by weight of the composition of perfume.

According to a second aspect, there is provided a method of providing sustained freshness to a surface comprising the step of treating the surface with the composition of the invention. Preferably, the surface is a fabric or a hard surface. Preferably the method is a cleaning process. Preferably, the method is a laundry process.

The composition and method of the invention provide not only in-use freshness but also sustained freshness on surfaces, preferably on fabrics or hard surfaces.

Lastly, there is provided the use of a composition to provide sustained freshness on surfaces, preferably on fabrics. The spores are stable in the composition and do not germinate until the treated surface is exposed to the right environment, such as the presence of nutrients, certain temperature and certain humidity.

The elements of the composition described in relation to the first aspect apply mutatis mutandis to the other aspects.

### DETAILED DESCRIPTION OF THE INVENTION

The present application encompasses a composition comprising Bacillus spores, a pro-perfume material and a perfume. The present application also encompasses a method of providing sustained freshness to a surface using the composition of the invention. The present application also encompasses the use of the method and the composition to provide bacterial spore and pro-perfume deposition on a surface, preferably a fabric or a hard surface, that in turn provides sustained malodor removal and/or malodor prevention and perfume release from the surface. By “sustained freshness” is meant that the malodor removal and/or prevention and perfume release take place for at least 24 hours, preferably for at least 48 hours after the surface has been treated.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

All percentages, ratios and proportions used herein are by weight percent of the composition, unless otherwise specified. All average values are calculated “by weight” of the composition, unless otherwise expressly indicated. All ratios are calculated as a weight/weight level, unless otherwise specified.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

### Composition

The present disclosure relates to a composition for treating a surface. The composition is suitable for use on hard surfaces and soft surfaces. Preferably the composition of the invention comprises a surfactant system. The composition may be a cleaning composition. It may be hard surface cleaning or laundry cleaning composition. In the case of hard surface cleaning, it is preferably an aqueous composition, it may be acid or alkaline and it may be in concentrated form or in the form of ready-to-use composition. Alternatively, the hard surface cleaning composition can be in the form of a bead. In the case of hard surface cleaning beads, the composition may comprise a plurality of particles, said particles comprise:
1. from 20% to 70% of polyalkylene glycol having a weight average molecular weight from 2000 to 40000 by total weight of said particles;
2. from 10% to 70% of an effervescent system by total weight of said particles; and
3. from 0.1% to 50% of perfume by total weight of said particles.

The composition may be a laundry additive, such as a bead or a drying sheet. The composition may be a fabric enhancer composition.

By “hard surface cleaning composition”, it is meant herein a based liquid composition for cleaning hard surfaces found in households, especially domestic households. Surfaces to be cleaned include kitchens and bathrooms, e.g., floors, walls, tiles, windows, cupboards, sinks, showers, plastified shower curtains, wash basins, WCs, fixtures and fittings and the like made of different materials like ceramic, vinyl, no-wax vinyl, linoleum, melamine, glass, steel, kitchen work surfaces, any plastics, plastified wood, metal or any painted or varnished or sealed surface and the like. Household hard surfaces also include household appliances including, but not limited to refrigerators, freezers, washing machines, automatic dryers, ovens, microwave ovens, dishwashers and so on. Such hard surfaces may be found both in private households as well as in commercial, institutional and industrial environments. Preferably, the hard surface cleaning composition is an aqueous composition.

Soft surfaces treating compositions may include but are not limited to, laundry cleaning compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the wash and/or rinse cycle of the laundering process.

The composition may be in any suitable form. It may be in the form of a liquid composition, a granular composition, a single-compartment pouch, a multi-compartment pouch, a sheet, a pastille or bead, a fibrous article, a tablet, a bar, flake, or a mixture thereof. The product can be selected from a liquid, solid, or combination thereof.

The composition may be in liquid form. The composition may include from about 30% to about 90%, or from about 50% to about 80%, by weight of the composition, of water. The pH of the composition may be optimized to facilitate bacterial spores stability.

The composition may be a cleaning or additive composition, it may be in the form of a unitized dose article, such as a tablet, a pouch, a sheet, or a fibrous article. Such pouches typically include a water-soluble film, such as a polyvinyl alcohol water-soluble film, that at least partially encapsulates a composition. Suitable films are available from MonoSol, LLC (Indiana, USA). The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch or compartments thereof may be liquid, solid (such as powders), or combinations thereof. Pouched compositions may have relatively low amounts of water, for example less than about 20%, or less than about 15%, or less than about 12%, or less than about 10%, or less than about 8%, by weight of the detergent composition, of water.

The composition may be in the form of a pastille or bead. The pastille may include polyethylene glycol as a carrier. The polyethylene glycol may have a weight average molecular weight of from about 2000 to about 20,000 Daltons, preferably from about 5000 to about 15,000 Daltons, more preferably from about 6,000 to about 12,000 Daltons.

The composition may comprise a non-aqueous solvent, which may act as a carrier and/or facilitate stability. Non-aqueous solvents may include organic solvents, such as methanol, ethanol, propanol, isopropanol, 1,3-propanediol, 1,2-propanediol, ethylene glycol, glycerine, glycol ethers, hydrocarbons, or mixtures thereof. Other non-aqueous solvents may include lipophilic fluids such as siloxanes or other silicones, hydrocarbons, perfluorinated amines, perfluorinated and hydrofluoroether solvents, or mixtures thereof. Amine-containing solvents, such as monoethanolamine, diethanolamine and triethanolamine, may be suitable.

### Bacterial Spores

The composition of the invention comprises from about 1×10² to about 1×10⁹ CFU/g, preferably from 1×10³ to about 1×10⁷ CFU/g and more preferably from 1×10⁴ to about 1×10⁷ CFU/g of the composition of Bacillus spores. Although bacterial spores can be present on surfaces, the method of the invention involves the intentional addition of bacterial spores to the surface in an amount capable of providing a consumer noticeable benefit, in particular sustained perfume release. Preferably, the method of the invention requires the intentional addition of at least 1×10² CFU/g of surface and preferably less than 1×10⁷ CFU/g of surface. Preferably if the surface is a fabric and the fabric is treated in a laundry process then the level of bacterial spores is from about 1×10² to 1×10⁴ CFU/g of surface. And for methods involving direct applications, such as sprays, the level of bacterial spores would be from about 1×10⁴ to 1×10⁶ CFU/g of surface. By “intentional addition of bacterial spores” is herein meant that the spores are added in addition to the microorganisms that might be present on the surface.

The composition of the invention can be in the form of a fabric treatment composition and it may be added to a wash, rinse or drying cycle, preferably the composition is added into a wash or rinse cycle. The spores are not deactivated by heat at the temperatures found in a washing machine or in a dryer. The spores are fabric-substantive and provide fragrance release benefit.

The bacterial spores of the method and composition of the invention can germinate on surfaces. The spores can be activated by heat, for example, heat generated during use of the fabric or by the heat provided in the washing machine. The spores can germinate when the fabrics are stored and/or used. The enzymes excreted by the bacteria trigger the release of perfume molecules from the pro-perfumes.

The fabric can be treated in a wet laundry process, or it can be treated wet after being washed, for example in the dryer or being sprayed. Alternatively, the fabric can be treated with a composition in the form of a spray in order to refresh it.

The bacterial spores for use herein: i) are capable of surviving the temperatures found in a laundry process; ii) are fabric substantive; and iii) have the ability to excrete enzymes and release the perfume from the pro-perfume material. The spores have the ability to germinate and to form cells during the use of the surface. The spores can be delivered in liquid or solid form. Preferably, the spores are in solid form.

Some gram-positive bacteria have a two-stage lifecycle in which growing bacteria under certain conditions such as in response to nutritional deprivation can undergo an elaborate developmental program leading to spores or endospores formation. The bacterial spores are protected by a coat consisting of about 60 different proteins assembled as a biochemically complex structure with intriguing morphological and mechanical properties. The protein coat is considered a static structure that provides rigidity and mainly acting as a sieve to exclude exogenous large toxic molecules, such as lytic enzymes. Spores play critical roles in long term survival of the species because they are highly resistant to extreme environmental conditions. Spores are also capable of remaining metabolically dormant for years. Methods for obtaining bacterial spores from vegetative cells are well known in the field. In some examples, vegetative bacterial cells are grown in liquid medium. Beginning in the late logarithmic growth phase or early stationary growth phase, the bacteria may begin to sporulate. When the bacteria have finished sporulating, the spores may be obtained from the medium, by using centrifugation for example. Various methods may be used to kill or remove any remaining vegetative cells. Various methods may be used to purify the spores from cellular debris and/or other materials or substances. Bacterial spores may be differentiated from vegetative cells using a variety of techniques, like phase-contrast microscopy, automated scanning microscopy, high resolution atomic force microscopy or tolerance to heat, for example. Because bacterial spores are generally environmentally-tolerant structures that are metabolically inert or dormant, they are readily chosen to be used in commercial microbial products. Despite their ruggedness and extreme longevity, spores can rapidly respond to the presence of small specific molecules known as germinants that signal favorable conditions for breaking dormancy through germination, an initial step in the process of completing the lifecycle by returning to vegetative bacteria. For example, the commercial microbial products may be designed to be dispersed into an environment where the spores encounter the germinants present in the environment to germinate into vegetative cells and perform an intended function. A variety of different bacteria may form spores. Bacteria from any of these groups may be used in the compositions, methods, and kits disclosed herein. For example, some bacteria of the following genera may form spores: Acetonema, Alkalibacillus, Ammoniphilus, Amphibacillus, Anaerobacter, Anaerospora, Aneurinibacillus, Anoxybacillus, Bacillus, Brevibacillus, Caldanaerobacter, Caloramator, Caminicella, Cerasibacillus, Clostridium, Clostridiisalibacter, Cohnella, Dendrosporobacter, Desulfotomaculum, Desulfosporomusa, Desulfosporosinus, Desulfovirgula, Desulfunispora, Desulfurispora, Filifactor, Filobacillus, Gelria, Geobacillus, Geosporobacter, Gracilibacillus, Halonatronum, Heliobacterium, Heliophilum, Laceyella, Lentibacillus, Lysinibacillus, Mahella, Metabacterium, Moorella, Natroniella, Oceanobacillus, Orenia, Ornithinibacillus, Oxalophagus, Oxobacter, Paenibacillus, Paraliobacillus, Pelospora, Pelotomaculum, Piscibacillus, Planifilum, Pontibacillus, Propionispora, Salinibacillus, Salsuginibacillus, Seinonella, Shimazuella, Sporacetigenium, Sporoanaerobacter, Sporobacter, Sporobacterium, Sporohalobacter, Sporolactobacillus, Sporomusa, Sporosarcina, Sporotalea, Sporotomaculum, Syntrophomonas, Syntrophospora, Tenuibacillus, Tepidibacter, Terribacillus, Thalassobacillus, Thermoacetogenium, Thermoactinomyces, Thermoalkalibacillus, Thermoanaerobacter, Thermoanaeromonas, Thermobacillus, Thermoflavimicrobium, Thermovenabulum, Tuberibacillus, Virgibacillus, and/or Vulcanobacillus.

Preferably, the bacteria that may form spores are from the family Bacillaceae, such as species of the genera Aeribacillus, Aliibacillus, Alkalibacillus, Alkalicoccus, Alkalihalobacillus, Alkalilactibacillus, Allobacillus, Alteribacillus, Alteribacter, Amphibacillus, Anaerobacillus, Anoxybacillus, Aquibacillus, Aquisalibacillus, Aureibacillus, Bacillus, Caldalkalibacillus, Caldibacillus, Calditerricola, Calidifontibacillus, Camelliibacillus, Cerasibacillus, Compostibacillus, Cytobacillus, Desertibacillus, Domibacillus, Ectobacillus, Evansella, Falsibacillus, Ferdinandcohnia, Fermentibacillus, Fictibacillus, Filobacillus, Geobacillus, Geomicrobium, Gottfriedia, Gracilibacillus, Halalkalibacillus, Halobacillus, Halolactibacillus, Heyndrickxia, Hydrogenibacillus, Lederbergia, Lentibacillus, Litchfieldia, Lottiidibacillus, Margalitia, Marinococcus, Melghiribacillus, Mesobacillus, Metabacillus, Microaerobacter, Natribacillus, Natronobacillus, Neobacillus, Niallia, Oceanobacillus, Ornithinibacillus, Parageobacillus, Paraliobacillus, Paralkalibacillus, Paucisalibacillus, Pelagirhabdus, Peribacillus, Piscibacillus, Polygonibacillus, Pontibacillus, Pradoshia, Priestia, Pseudogracilibacillus, Pueribacillus, Radiobacillus, Robertmurraya, Rossellomorea, Saccharococcus, Salibacterium, Salimicrobium, Salinibacillus, Salipaludibacillus, Salirhabdus, Salisediminibacterium, Saliterribacillus, Salsuginibacillus, Sediminibacillus, Siminovitchia, Sinibacillus, Sinobaca, Streptohalobacillus, Sutcliffiella, Swionibacillus, Tenuibacillus, Tepidibacillus, Terribacillus, Terrilactibacillus, Texcoconibacillus, Thalassobacillus, Thalassorhabdus, Thermolongibacillus, Virgibacillus, Viridibacillu, Vulcanibacillus, Weizmannia. In various examples, the bacteria may be strains of Bacillus Bacillus acidicola, Bacillus aeolius, Bacillus aerius, Bacillus aerophilus, Bacillus albus, Bacillus altitudinis, Bacillus alveayuensis, Bacillus amyloliquefaciensex, Bacillus anthracis, Bacillus aquiflavi, Bacillus atrophaeus, Bacillus australimaris, Bacillus badius, Bacillus benzoevorans, Bacillus cabrialesii, Bacillus canaveralius, Bacillus capparidis, Bacillus carboniphilus, Bacillus cereus, Bacillus chungangensis, Bacillus coahuilensis, Bacillus cytotoxicus, Bacillus decisifrondis, Bacillus ectoiniformans, Bacillus enclensis, Bacillus fengqiuensis, Bacillus fungorum, Bacillus glycinifermentans, Bacillus gobiensis, Bacillus halotolerans, Bacillus haynesii, Bacillus horti, Bacillus inaquosorum, Bacillus infantis, Bacillus infernus, Bacillus isabeliae, Bacillus kexueae, Bacillus licheniformis, Bacillus luti, Bacillus manusensis, Bacillus marinisedimentorum, Bacillus mesophilus, Bacillus methanolicus, Bacillus mobilis, Bacillus mojavensis, Bacillus mycoides, Bacillus nakamurai, Bacillus ndiopicus, Bacillus nitratireducens, Bacillus oleivorans, Bacillus pacificus, Bacillus pakistanensis, Bacillus paralicheniformis, Bacillus paramycoides, Bacillus paranthracis, Bacillus pervagus, Bacillus piscicola, Bacillus proteolyticus, Bacillus pseudomycoides, Bacillus pumilus, Bacillus safensis, Bacillus salacetis, Bacillus salinus, Bacillus salitolerans, Bacillus seohaeanensis, Bacillus shivajii, Bacillus siamensis, Bacillus smithii, Bacillus solimangrovi, Bacillus songklensis, Bacillus sonorensis, Bacillus spizizenii, Bacillus spongiae, Bacillus stercoris, Bacillus stratosphericus, Bacillus subtilis, Bacillus swezeyi, Bacillus taeanensis, Bacillus tamaricis, Bacillus tequilensis, Bacillus thermocloacae, Bacillus thermotolerans, Bacillus thuringiensis, Bacillus tianshenii, Bacillus toyonensis, Bacillus tropicus, Bacillus vallismortis, Bacillus velezensis, Bacillus wiedmannii, Bacillus wudalianchiensis, Bacillus xiamenensis, Bacillus xiapuensis, Bacillus zhangzhouensis, or combinations thereof.

In some examples, the bacterial strains that form spores may be strains of Bacillus, including: Bacillus sp. strain SD-6991; Bacillus sp. strain SD-6992; Bacillus sp. strain NRRL B-50606; Bacillus sp. strain NRRL B-50887; Bacillus pumilus strain NRRL B-50016; Bacillus amyloliquefaciens strain NRRL B-50017; Bacillus amyloliquefaciens strain PTA-7792 (previously classified as Bacillus atrophaeus); Bacillus amyloliquefaciens strain PTA-7543 (previously classified as Bacillus atrophaeus); Bacillus amyloliquefaciens strain NRRL B-50018; Bacillus amyloliquefaciens strain PTA-7541; Bacillus amyloliquefaciens strain PTA-7544; Bacillus amyloliquefaciens strain PTA-7545; Bacillus amyloliquefaciens strain PTA-7546; Bacillus subtilis strain PTA-7547; Bacillus amyloliquefaciens strain PTA-7549; Bacillus amyloliquefaciens strain PTA-7793; Bacillus amyloliquefaciens strain PTA-7790; Bacillus amyloliquefaciens strain PTA-7791; Bacillus subtilis strain NRRL B-50136 (also known as DA-33R, ATCC accession No. 55406); Bacillus amyloliquefaciens strain NRRL B-50141; Bacillus amyloliquefaciens strain NRRL B-50399; Bacillus licheniformis strain NRRL B-50014; Bacillus licheniformis strain NRRL B-50015; Bacillus amyloliquefaciens strain NRRL B-50607; Bacillus subtilis strain NRRL B-50147 (also known as 300R); Bacillus amyloliquefaciens strain NRRL B-50150; Bacillus amyloliquefaciens strain NRRL B-50154; Bacillus megaterium PTA-3142; Bacillus amyloliquefaciens strain ATCC accession No. 55405 (also known as 300); Bacillus amyloliquefaciens strain ATCC accession No. 55407 (also known as PMX); Bacillus pumilus NRRL B-50398 (also known as ATCC 700385, PMX-1, and NRRL B-50255); Bacillus cereus ATCC accession No. 700386; Bacillus thuringiensis ATCC accession No. 700387 (all of the above strains are available from Novozymes, Inc., USA); Bacillus amyloliquefaciens FZB24 (e.g., isolates NRRL B-50304 and NRRL B-50349 TAEGRO® from Novozymes), Bacillus pumilus (e.g., isolate NRRL B-50349 from Bayer CropScience), Bacillus amyloliquefaciens TrigoCor (also known as “TrigoCor 1448”; e.g., isolate Embrapa Trigo Accession No. 144/88.4Lev, Cornell Accession No. Pma007BR-97, and ATCC accession No. 202152, from Cornell University, USA) and combinations thereof.

In some examples, the bacterial strains that form spores may be strains of Bacillus amyloliquefaciens. For example, the strains may be Bacillus amyloliquefaciens strain PTA-7543 (previously classified as Bacillus atrophaeus), and/or Bacillus amyloliquefaciens strain NRRL B-50154, Bacillus amyloliquefaciens strain PTA-7543 (previously classified as Bacillus atrophaeus), Bacillus amyloliquefaciens strain NRRL B-50154, or from other Bacillus amyloliquefaciens organisms.

In some examples, the bacterial strains that form spores may be Brevibacillus spp., e.g., Brevibacillus brevis; Brevibacillus formosus; Brevibacillus laterosporus; or Brevibacillus parabrevis, or combinations thereof.

In some examples, the bacterial strains that form spores may be Paenibacillus spp., e.g., Paenibacillus alvei; Paenibacillus amylolyticus; Paenibacillus azotofixans; Paenibacillus cookii; Paenibacillus macerans; Paenibacillus polymyxa; Paenibacillus validus, or combinations thereof.

The bacterial spores may have an average particle diameter of about 2-50 microns, suitably about 10-45 microns. Bacillus spores are commercially available in blends in aqueous carriers and are insoluble in the aqueous carriers. Other commercially available bacillus spore blends include without limitation Freshen Free™ CAN (10×), available from Novozymes Biologicals, Inc.; Evogen® Renew Plus (10×), available from Genesis Biosciences, Inc.; and Evogen® GT (10×, 20× and 110×), all available from Genesis Biosciences, Inc. In the foregoing list, the parenthetical notations (10×, 20×, and 110×) indicate relative concentrations of the Bacillus spores.

Bacterial spores used in the compositions, methods, and products disclosed herein may or may not be heat activated. In some examples, the bacterial spores are heat activated. In some examples, the bacterial spores are not heat inactivated. Preferably, the spores used herein are heat activated. Heat activation may comprise heating bacterial spores from room temperature (15-25° C.) to optimal temperature of between 25-120° C., preferably between 40 C-100° C., and held the optimal temperature for not more than 2 hours, preferably between 70-80° C. for 30 min.

For the methods and compositions disclosed herein, populations of bacterial spores are generally used. In some examples, a population of bacterial spores may include bacterial spores from a single strain of bacterium. Preferably, a population of bacterial spores may include bacterial spores from 2, 3, 4, 5, or more strains of bacteria. Generally, a population of bacterial spores contains a majority of spores and a minority of vegetative cells. In some examples, a population of bacterial spores does not contain vegetative cells. In some examples, a population of bacterial spores may contain less than about 1%, 2%, 3%, 4%, 5%, 6%, 7%, 8%, 9%, 10%, 15%, 20%, 25%, 30%, 40%, or 50% vegetative cells, where the percentage of bacterial spores is calculated as ((vegetative cells/(spores in population+vegetative cells in population))×100). Generally, populations of bacterial spores used in the disclosed methods, compositions and products are stable (i.e. not undergoing germination), with at least some individual spores in the population capable of germinating.

### Pro-Perfume Materials

The composition of the present disclosure comprises pro-perfume materials. Sometimes referred to as pro-fragrances or fragrance precursors. Pro-perfume materials typically comprise a covalent bond between a carrier and one or more perfume raw material(s) (PRM(s)). Once the spores germinate, the one or more PRMs are then released upon exposure to enzymes excreted by the bacteria. Pro-perfume materials can provide extended PRMs release profiles, resulting in long-lasting freshness benefits. Furthermore, because the total amount of PRMs is not released or otherwise available at one time, the olfactory impact of the PRMs is moderated. In compositions of the present invention, such release profiles can mitigate what might otherwise be experienced as an overpowering smell, due to the relatively high levels of fragrance.

The pro-perfume material of the composition of the present invention comprises PRM. The pro-perfume material is capable of releasing the PRM when exposed to the enzymes released by the bacteria.

The pro-perfume material may gradually release the PRM when the spores germinate and the bacteria contained in the spore excrete enzymes. The germination of the spores is not triggered during product storage but only during and after the product is used. Good conditions for spore germination are for example found during the wearing of treated fabrics, in particular when the body of the user is sweating.

Pro-perfume materials for use herein are selected from the group consisting of glycosides, phosphate acid esters, amino-acid derivatives and carboxylic acid derivatives and mixtures thereof. Especially preferred pro-perfumes to use in the composition and method of the invention comprise glycosides pro-perfumes.

The composition of the invention preferably comprises from about 0.01% to about 10%, preferably from about 0.05% to about 5% by weight of the composition of pro-perfumes.

### Glycosides

The glycoside pro-perfume materials comprise at least one sugar component covalently bonded to an aglycon component capable of releasing a ‘fragrant alcohol’ after hydrolysis.

A “glycoside”, as used herein, is a molecule in which a sugar (the “glycone” part or “glycone component” of the glycoside) is bonded to a non-sugar (the “aglycone” part or “aglycone component”) via a glycosidic bond. Accordingly, a glycoside may consist of a sugar as glycone component linked through its anomeric carbon atom to e.g. the hydroxy group of an alcohol (chemical structure R—OH) as aglycone component.

The sugar part of the glycosides may include monosaccharides such as glucose, galactose, mannanose, rhamnose, ylose, ribose, arabinose, glucosamine and galactosamine; and disaccharides such as lactose, maltose, sucrose, cellobiose, isomaltose and epilactose.

The aglycon corresponding to the ‘fragrant alcohol’ component in the aforesaid glycoside may include any ‘fragrant alcohol’. While not providing an exhaustive list, provided here is a list of alcohols which are capable of imparting pleasant odors. The ‘fragrant alcohols’ may be selected from the group consisting such as, but not limited to: anisic alcohol, cinnamic alcohol, fenchylic alcohol, 9-decen-1-ol, phenethylol, citronellol, 3-methyl-5-phenyl-1-pentanol (origin: Firmenich SA. Geneva. Switzerland), Mayol® (4-isopropylcyclohexyl)methanol; origin: Firmenich SA. Geneva. Switzerland), dihydromyrcenol (2.6-dimethyl-7-octen-2-ol), geraniol (3.7-dimethyl-2.6-octadien-1-ol), (Z)-3-hexen-1-ol, 1-hexanol, 2-hexanol, 5-ethyl-2-nonanol, 2,6-nonadien-1-ol, borneol, 1-octen-3-ol, 4-cyclohexyl-2-methyl-2-butanol (origin: Firmenich SA. Geneva. Switzerland), 2-methyl-4-phenyl-2-butanol, 2-methyl-1-phenyl-2-propanol, cyclomethylcitronellol, decanol, dihydroeugenol, 8-p-menthanol, 3,7-dimethyl-1-octanol, 2,6-dimethyl-2-heptanol, 1-dodecanol, eugenol, Florol® (tetrahydro-2-isobutyl-4-methyl-4(2H)-pyranol; origin: Firmenich SA. Geneva. Switzerland), isoeugenol, linalool, Tarragol® (2-methoxy-4-propyl-1-cyclohexanol; origin: Firmenich SA. Geneva, Switzerland), alpha-terpineol, tetrahydromuguol, 3,7-dimethyl-3-octanol, Lyral® (4-(4-hydroxy-4-methylpentyl)-cyclohex-3-ene-1-carbaldehyde: origin International Flavors and Fragrances. USA), Furaneol® (origin: Firmenich SA. Geneva. Switzerland), 5,6-dimethyl-1-methylethenylbicyclo[2.2.1]hept-5-ene-2-methanol (Arbozol), 2-phenyethanol, 1-phenylpropanol, 2-phenylpropanol, Lilyflore® ((2,5-dimethyl-2,3-dihydro-1H-inden-2-yl)methanol; origin: Firmenich SA. Geneva. Switzerland), 2,2-dimethyl-3-(3-methylphenyl)-propan-1-ol (Majantol), 2-pentylcyclopentanol, 7-hydroxy-3,7-dimethyloctanal (hydroxycitronellol), 1,1-dimethyl-2-phenylethanol, 4-cyclohexyl-2-methylbutan-2-ol, menthol, 2,6-dimethylheptan-2-ol, 2-tert-butylcyclohexanol, 4-tert-butylcyclohexanol, 2,6-dimethyl-3,5-octadien-2-ol (muguol), 2-methyl-6-methylene-7-octen-2-ol (myrcenol), 3,7,9-trimethyl-1,6-decadien-3-ol (isobutyl linalool), methyl salicylate, cis-3-hexenyl salicylate, 3,6-dimethyloctan-3-ol, 1,2-dimethyl-3-prop-1-en-2-ylcyclopentan-1-ol (plinol), 2-methyl-4-phenylpentanol (Pamplefleur), 3-methyl-5-phenylpentanol, 3-methyl-5-(2,2,3-trimethyl-1-cyclopent-3-enyl)pentan-2-ol (Sandalore®), (E)-3,3-dimethyl-5-(2,2,3-trimethyl-3-cyclopenten-1-yl)-4-penten-2-ol (Polysantol®), 1-(2,2,6-trimethylcyclohexyl)hexan-3-ol (Norlimbanol™), (E)-4-methyldec-3-en-5-ol, and 4-(4-hydroxyphenyl)butan-2-one.

The glycoside pro-perfumes used in the invention may be either an α- or β-form, or a mixture of α- and β-forms. i.e., the bond between aglycon and sugar may be either an α- or β-bond. β-Form may be preferred as these are readily decomposed by beta-glucosidase enzymes produced by the microorganisms.

Many of these glycosides are commercially available with ease. They may also be easily synthesized in known methods. For example, they may be easily synthesized by reacting sugars with the aforesaid alcohols in the presence of acids. It is possible to synthesize only the β-form using the known Königs-Knorr Reaction. The glycoside pro-perfumes may also be produced through biocatalysis, e.g. using a glucosyltransferase or whole cell systems. Non-limiting examples of specific suitable beta glucoside pro-perfumes, their released ‘fragrant alcohol’ and aroma, all commercially available from Goldmann, Bielefeld, Germany, are listed in the table below.

Preferably, the composition of the invention comprises an alkyl polyglucoside. The alkyl polyglucoside can be selected from C6-C18 alkyl polyglucoside. The alkyl polyglucoside can have a number average degree of polymerization of from 0.1 to 3.0, preferably from 1.0 to 2.0, more preferably from 1.2 to 1.6. The alkyl polyglucoside can comprise a blend of short chain alkyl polyglucoside having an alkyl chain comprising 10 carbon atoms or less, and mid to long chain alkyl polyglucoside having an alkyl chain comprising greater than 10 carbon atoms to 18 carbon atoms, preferably from 12 to 14 carbon atoms.

Short chain alkyl polyglucosides have a monomodal chain length distribution between C8-C10, mid to long chain alkyl polyglucosides have a monomodal chain length distribution between C10-C18, while mid chain alkyl polyglucosides have a monomodal chain length distribution between C12-C14. In contrast, C8 to C18 alkyl polyglucosides typically have a monomodal distribution of alkyl chains between C8 and C18, as with C8 to C₁₆ and the like. As such, a combination of short chain alkyl polyglucoside surfactants with mid to long chain or mid chain alkyl polyglucosides can have a broader distribution of chain lengths, or even a bimodal distribution, than non-blended C8 to C18 alkyl polyglucosides. Preferably, the weight ratio of short chain alkyl polyglucoside to long chain alkyl polyglucoside is from 1:1 to 10:1, preferably from 1.5:1 to 5:1, more preferably from 2:1 to 4:1. It has been found that a blend of such short chain alkyl polyglucoside can result in faster dissolution of the composition in water.

C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation). Glucopon® 215UP is a preferred short chain alkyl polyglucoside. Glucopon® 600CSUP is a preferred mid to long chain alkyl polyglucoside.

Preferably, the composition of the invention comprises a monoglucoside.

| Beta glucoside | Released ‘fragrant | | |
|---|---|---|---|
| Properfume | alcohol’ name/synonym | CAS No. | Aroma |
| Carvacrol glucoside | Carvacrol | 499-75-2 | Oregano |
| | 5-Isopropyl-2-methylphenol | | |
| Citronellol glucoside | Citronellol | 106-22-9 | Citrus |
| | Citronellol, racemic | | |
| Ethyl maltol glucoside | Ethyl maltol | 4940-11-8 | Malt, caramel |
| | 2-Ethyl-3-hydroxy-4-pyranone | | |
| Eugenol glucoside | Eugenol | 97-53-0 | Spice clove |
| | 4-Allyl-2-methoxyphenol | | |
| Furaneol glucoside | Furaneol | 3658-77-3 | Caramel, |
| | 4-Hydroxy-2,5-dimethyl-3-furanone | | Strawberry |
| Geraniol glucoside | Geraniol | 106-24-1 | flowery |
| | Geranyl alcohol | | |
| Hexanol glucoside | Hexanol | 111-27-3 | Sweet |
| | 1-Hexanol | | |
| 3-cis-Hexanol glucoside | 3-cis-Hexenol | 928-96-1 | Green leaves |
| | cis-3-Hexen-1-ol | | |
| Homofuraneol glucoside | Homofuraneol | 27538-10-9, | Caramel |
| | 2-Ethyl-4-hydroxi-5-methyl-3- | 27538-09-6 | |
| | furanone | | |
| Linalool glucoside | Linalool | 78-70-6, | Flowery |
| | Linalyl alcohol | 126-91-06 | |
| Maltol glucoside | Maltol | 118-71-8 | Malt, caramel |
| | 3-Hydroxy-2-methyl-pyran-4-one | | |
| Menthol glucoside | Menthol | 2216-51-5, | Peppermint |
| | 2-Isopropyl-5-methylcyclohexanol | 89-78-1 | |
| Nerol glucoside | Nerol | 106-25-2 | Rose, citrus |
| | 2,6-Dimethyl-2,6-octadien-8-ol | | |
| Norfuraneol glucoside | Norfuraneol | 19322-27-1 | Caramel |
| | 4-Hydroxy-5-methylfuran-3-one | | |
| 2-Phenylethanol | 2-Phenylethanol | 60-12-8 | Rose |
| glucoside | Phenylethylalcohol | | |
| Raspberry ketone | Raspberry ketone | 5471-51-2 | Raspberry |
| glucoside | Rheosmin | | |
| Terpineol glucoside | Terpineol | 10482-56-1, | Etheric |
| | α-Terpineol | 8000-41-7 | |
| Thymol glucoside | Thymol | 89-83-8 | Thyme |
| | 2-Isopropyl-5-methylphenol | | |
| Vanillin aldehyde | Vanillin aldehyde | 121-33-5 | Vanilla |
| glucoside | 4-Hydroxy-3-methoxybenzaldehyde | | |

### Phosphate Acid Esters

The phosphoric acid esters of perfumes used in the invention may include phosphates and pyrophosphates. Alkyl moieties corresponding to a perfume component may include alkyl, alkenyl, alkynyl and aralkyl groups having 5 to 15 carbon atoms which may be branched and may have functional groups such as amyl, nonyl, geranyl, neryl, linalyl, hexenyl, nonadienyl, phenethyl and cinnamyl groups. As a perfume component, use may be made of the same ones as mentioned for the aforesaid glycosides, some of which fall also under the definition given here.

Many of these phosphoric acid ester derivatives are commercially available with ease. They may also be easily synthesized in known methods. For example, they may be easily synthesized from alkyl alcohols or alkyl halogenides and phosphorus oxychloride or diphosphoric esters in accordance with the known method described in J. Org. Chem. 1989, 54, 1338-1342; or Methods. Enzymol., 110,130 (1985).

### Amino Acid Derivatives

The amino acid derivatives of perfumes used in the invention may include amino acid esters, amino acid carbamates, N-alkyl amino acids, S-alkyl amino acids and S-oxide alkyl amino acids. An amino acid of which the amino acid derivative is composed may include cysteine, alanine, glutamic acid, glutamine, glycine and phenylalanine. Alkyl moieties corresponding to a perfume component may include alkyl, alkenyl, alkynyl and aralkyl groups having 5 to 15 carbon atoms which may be branched and may have functional groups such as amyl, nonyl, geranyl, neryl, linalyl, hexenyl, nonadienyl, phenethyl and cinnamyl groups. As a perfume component, use may be made of the same ones as mentioned for the aforesaid glycosides, some of which fall also under the definition given here.

One suitable specific example of an amino acid derivative is the amino acid carbamate produced between the alpha amino group of glutamine with Phenoxanol® shown below. Similar amino acid carbamate derivatives may be produced with the same glutamine carbamate moiety and other ‘fragrant alcohols’ such as those listed in the glycoside section above.

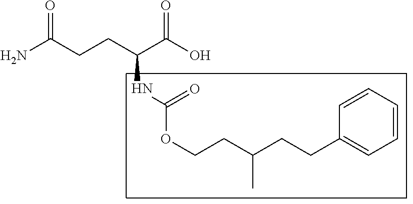 [SMILES: CC(CCOC(=O)N[C@@H](CCC(N)=O)C(=O)O)CCc1ccccc1]

### Carboxylic Acid Derivatives

The carboxylic acid derivatives of perfumes may include monocarboxylic acid esters and polycarboxylic acid esters. These involve esters of ‘fragrant alcohols’ (as defined with examples in the glycoside section above) with monocarboxylic acids or polycarboxylic acids. Suitable esters may be selected from esters of monocarboxylic acids including caprylic acid, pelargonic acid, capric acid, undecylic acid, lauric acid, tridecylic acid, myristic acid, pentadecylic acid, palmitic acid, margaric acid, stearic acid, nonadecylic acid and arachidic acid. Suitable esters may be selected from esters of polycarboxylic acids including succinic acid, tartaric acid and citric acid. Suitable esters may be produced by well-established chemical processes, such as reaction of the carboxylic acid with the ‘fragrant alcohol’ with acid catalysis, or reaction of an acid halide of the carboxylic acid with the ‘fragrant alcohol’. They may also be produced through transesterification of a lower alkyl ester such as triethyl citrate with the ‘fragrant alcohol’ component.

The polycarboxylic acid derivative used in the invention is an ester of a perfume component and a polycarboxylic acid. The polycarboxylic acid includes succinic acid, tartaric acid and citric acid. The polycarboxylic acid group may be those substituted by an ethyl or other group. As a perfume component, use may be made of the same ones as mentioned for the aforesaid glycosides. The polycarboxylic acid derivative in the present invention may be available with ease. They may also be easily synthesized by reacting a polycarboxylic acid with an alcohol corresponding to the perfume component in the presence of an acid. They may also be synthesized by an ester exchange reaction of a lower alkyl ester such as triethyl citrate with the perfume component. If desired, these polycarboxylic acid derivatives may be used after purified by, for example, distillation or column chromatography.

Non-limiting examples of specific suitable carboxylic acid derivatives include Hexarose® supplied by Firmenich, Geneva, Switzerland. This is the monocarboxylic acid ester of palmitic acid (hexadecanoic acid) with geraniol. Another example is digeranyl succinate. This is the polycarboxylic acid ester of succinic acid with geraniol involving two moles of geraniol per mole of succinic acid. Other examples are the mixed ester of succinic acid with nerol and geraniol, and the mixed ester of succinic acid with geraniol and Hedione® (methyl 3-oxo-2-pentyl-1-cyclopentaneacetate).

### Perfume

The composition of the invention comprises a perfume, preferably from about 0.001% to about 10%, more preferably from about 0.001 to about 5% by weight of the composition of perfume.

Said perfume may comprise perfume raw materials selected from the group consisting of alcohols, ketones, aldehydes, esters, ethers, nitriles alkenes and mixtures thereof. The perfume may comprise a perfume raw material selected from the group consisting of perfume raw materials having a boiling point (B.P.) lower than about 250° C. and a C log P lower than about 3, perfume raw materials having a B.P. of greater than about 250° C. and a C log P of greater than about 3, perfume raw materials having a B.P. of greater than about 250° C. and a C log P lower than about 3, perfume raw materials having a B.P. lower than about 250° C. and a C log P greater than about 3 and mixtures thereof. Perfume raw materials having a boiling point B.P. lower than about 250° C. and a C log P lower than about 3 are known as Quadrant I perfume raw materials, perfume raw materials having a B.P. of greater than about 250° C. and a C log P of greater than about 3 are known as Quadrant IV perfume raw materials, perfume raw materials having a B.P. of greater than about 250° C. and a C log P lower than about 3 are known as Quadrant II perfume raw materials, perfume raw materials having a B.P. lower than about 250° C. and a C log P greater than about 3 are known as a Quadrant III perfume raw materials. In one aspect, said perfume comprises a perfume raw material having B.P. of lower than about 250° C. In one aspect, said perfume comprises a perfume raw material selected from the group consisting of Quadrant I, II, III perfume raw materials and mixtures thereof. In one aspect, said perfume comprises a Quadrant III perfume raw material. Suitable Quadrant I, II, III and IV perfume raw materials are disclosed in U.S. Pat. No. 6,869,923 B1.

In one aspect, said perfume comprises a Quadrant IV perfume raw material. While not being bound by theory, it is believed that such Quadrant IV perfume raw materials can improve perfume odor “balance”. Said perfume may comprise, based on total perfume weight, less than about 30%, less than about 20%, or even less than about 15% of said Quadrant IV perfume raw material.

The perfume raw materials and accords may be obtained from one or more of the following companies Firmenich (Geneva, Switzerland), Givaudan (Argenteuil, France), IFF (Hazlet, N.J.), Quest (Mount Olive, N.J.), Bedoukian (Danbury, Conn.), Sigma Aldrich (St. Louis, Mo.), Millennium Specialty Chemicals (Olympia Fields, Ill.), Polarone International (Jersey City, N.J.), Fragrance Resources (Keyport, N.J.), and Aroma & Flavor Specialties (Danbury, Conn.).

Suitable cleaning ingredients include at least one of a surfactant system, an enzyme, an enzyme stabilizing system, a detergent builder, a chelating agent, a complexing agent, clay soil removal/anti-redeposition agents, polymeric soil release agents, polymeric dispersing agents, polymeric grease cleaning agents, a dye transfer inhibiting agent, a bleaching agent, a bleach activator, a bleaching catalyst, a fabric conditioner, a clay, a foam booster, an anti-foam, a suds suppressor, an anti-corrosion agent, a soil-suspending agent, a dye, a hueing dye, a bactericide, a tarnish inhibitor, an optical brightener, a perfume, a saturated or unsaturated fatty acid, a calcium cation, a magnesium cation, a visual signaling ingredient, a structurant, a thickener, an anti-caking agent, a starch, sand, a gelling agents, or any combination thereof.

Surfactant System: The composition may comprise a surfactant system in an amount sufficient to provide desired cleaning properties. In some embodiments, the composition comprises, by weight of the composition, from about 0.1% to about 70% of a surfactant system, preferably from about 0.5% to about 60% of the surfactant system. Preferably, the composition comprises, by weight of the composition, from about 1% to about 30% of the surfactant system. In the case of a ready-to-use hard cleaning surface composition, the composition may comprise from 0.01% to 5%, preferably from 0.1% to 4% by weight of the composition of surfactant system. The surfactant system may comprise a detersive surfactant selected from anionic surfactants, nonionic surfactants, cationic surfactants, zwitterionic surfactants, amphoteric surfactants, ampholytic surfactants, and mixtures thereof. Those of ordinary skill in the art will understand that a detersive surfactant encompasses any surfactant or mixture of surfactants that provide cleaning, stain removing, or laundering benefit to soiled material. Preferably, the surfactant system when present in the composition of the invention comprises and anionic surfactant and a non-ionic surfactant.

Anionic Surfactant. Non-limiting examples of suitable anionic surfactants include any conventional anionic surfactant, such as linear alkylbenzenesulfonate (LAS), alpha-olefinsulfonate (AOS), alkyl sulfate (fatty alcohol sulfate) (AS), alcohol ethoxysulfate (AEOS or AES), secondary alkanesulfonates (SAS), alpha-sulfo fatty acid methyl esters, alkyl- or alkenylsuccinic acid, or soap.

Nonionic surfactant. Suitable nonionic surfactants useful herein can comprise any conventional nonionic surfactant. These can include, for e.g., alkoxylated fatty alcohols and amine oxide surfactants. Other non-limiting examples of nonionic surfactants useful herein include: C₈-C₁₈ alkyl ethoxylates, such as, NEODOL® nonionic surfactants from Shell; C₆-C₁₂ alkyl phenol alkoxylates wherein the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols (BA); C₁₄-C₂₂ mid-chain branched MEA (BAEₓ), wherein x is from 1 to 30; polyhydroxy fatty acid amides; and ether capped poly(oxyalkylated) alcohol surfactants. Suitable nonionic detersive surfactants also include alkyl alkoxylated alcohol. Suitable nonionic surfactants also include those sold under the tradename Lutensol® from BASF.

Cationic Surfactant. The surfactant system may comprise a cationic surfactant. When the composition of the invention is a cleaning composition, the composition is preferably free of cationic surfactant. When the composition is a fabric enhancer, the composition preferably comprises a cationic surfactant. Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; cationic ester surfactants; and amino surfactants, specifically amido propyldimethylamine (APA).

Zwitterionic Surfactant. Examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. Betaines, including alkyl dimethyl betaine and cocodimethyl amidopropyl betaine, C₈ to C₁₈ (for example from C₁₂ to C₁₈) amine oxides and sulfo and hydroxy betaines, such as N-alkyl-N,N-dimethylammino-1-propane sulfonate where the alkyl group can be C₈ to C₁₈ and in certain embodiments from C₁₀ to C₁₄.

Amphoteric Surfactant. Examples of amphoteric surfactants include aliphatic derivatives of secondary or tertiary amines, or aliphatic derivatives of heterocyclic secondary and tertiary amines in which the aliphatic radical may be straight- or branched-chain and where one of the aliphatic substituents contains at least about 8 carbon atoms, typically from about 8 to about 18 carbon atoms, and at least one of the aliphatic substituents contains an anionic water-solubilizing group, e.g. carboxy, sulfonate, sulfate. Examples of compounds falling within this definition are sodium 3-(dodecylamino)propionate, sodium 3-(dodecylamino) propane-1-sulfonate, sodium 2-(dodecylamino)ethyl sulfate, sodium 2-(dimethylamino) octadecanoate, disodium 3-(N-carboxymethyldodecylamino)propane 1-sulfonate, disodium octadecyl-imminodiacetate, sodium 1-carboxymethyl-2-undecylimidazole, and sodium N,N-bis (2-hydroxyethyl)-2-sulfato-3-dodecoxypropylamine. Suitable amphoteric surfactants also include sarcosinates, glycinates, taurinates, and mixtures thereof.

Enzymes. Preferably the composition comprises one or more enzymes. Preferred enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, galactanases, pectate lyases, keratinases, reductases, oxidases, phenoloxidases, lipoxygenases, ligninases, pullulanases, tannases, pentosanases, malanases, ß-glucanases, arabinosidases, hyaluronidase, chondroitinase, laccase, and amylases, or mixtures thereof. Preferably, when the composition of the invention is a laundry composition, it comprises an amylase and a protease and optionally a lipase. Preferably, the compositions of the invention are free of glucanases.

Proteases. Preferably the composition comprises one or more proteases. Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:

(a) subtilisins (EC 3.4.21.62), especially those derived from Bacillus, such as Bacillus sp., B. lentus, B. alkalophilus, B. subtilis, B. amyloliquefaciens, B. pumilus, B. gibsonii, and B. akibaii described in WO2004067737, WO2015091989, WO2015091990, WO2015024739, WO2015143360, U.S. Pat. No. 6,312,936 B 1, U.S. Pat. Nos. 5,679,630, 4,760,025, DE102006022216A1, DE102006022224A1, WO2015089447, WO2015089441, WO2016066756, WO2016066757, WO2016069557, WO2016069563, WO2016069569.

(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.

(c) metalloproteases, especially those derived from Bacillus amyloliquefaciens described in WO07/044993A2; from Bacillus, Brevibacillus, Thermoactinomyces, Geobacillus, Paenibacillus, Lysinibacillus or Streptomyces spp. Described in WO2014194032, WO2014194054 and WO2014194117; from Kribella alluminosa described in WO2015193488; and from Streptomyces and Lysobacter described in WO2016075078.

(d) Protease having at least 90% identity to the subtilase from Bacillus sp. TY145, NCIMB 40339, described in WO92/17577 (Novozymes A/S), including the variants of this Bacillus sp TY145 subtilase described in WO2015024739, and WO2016066757.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark); those sold under the tradename Maxatase®, Maxacal®, Maxapem®, Properase®, Purafect®, Purafect Prime®, Purafect Ox®, FN3®, FN4®, Excellase® and Purafect OXP® by Dupont; those sold under the tradename Opticlean® and Optimase® by Solvay Enzymes; and those available from Henkel/Kemira, namely BLAP (sequence shown in FIG. 29 of U.S. Pat. No. 5,352,604), and KAP (Bacillus alkalophilus subtilisin with mutations A230V+S256G+S259N) from Kao.

Amylases. Preferably the composition may comprise an amylase. Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:

(a) variants described in WO 94/02597, WO 94/18314, WO96/23874 and WO 97/43424, especially the variants with substitutions in one or more of the following positions versus the enzyme listed as SEQ ID No. 2 in WO 96/23874: 15, 23, 105, 106, 124, 128, 133, 154, 156, 181, 188, 190, 197, 202, 208, 209, 243, 264, 304, 305, 391, 408, and 444.

(b) variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643:

26, 30, 33, 82, 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, preferably that also contain the deletions of D183* and G184*.

(c) variants exhibiting at least 90% identity with SEQ ID No. 4 in WO06/002643, the wild-type enzyme from Bacillus SP722, especially variants with deletions in the 183 and 184 positions and variants described in WO 00/60060, which is incorporated herein by reference.

(d) variants exhibiting at least 95% identity with the wild-type enzyme from Bacillus sp. 707 (SEQ ID NO:7 in U.S. Pat. No. 6,093,562), especially those comprising one or more of the following mutations M202, M208, S255, R172, and/or M261. Preferably said amylase comprises one or more of M202L, M202V, M202S, M202T, M202I, M202Q, M202W, S255N and/or R172Q. Particularly preferred are those comprising the M202L or M202T mutations.

(e) variants described in WO 09/149130, preferably those exhibiting at least 90% identity with SEQ ID NO: 1 or SEQ ID NO:2 in WO 09/149130, the wild-type enzyme from Geobacillus Stearophermophilus or a truncated version thereof.

(f) variants exhibiting at least 89% identity with SEQ ID NO:1 in WO2016091688, especially those comprising deletions at positions H183+G184 and additionally one or more mutations at positions 405, 421, 422 and/or 428.

(g) variants exhibiting at least 60% amino acid sequence identity with the “PcuAmyl α-amylase” from Paenibacillus curdlanolyticus YK9 (SEQ ID NO:3 in WO2014099523).

(h) variants exhibiting at least 60% amino acid sequence identity with the “CspAmy2 amylase” from Cytophaga sp. (SEQ ID NO:1 in WO2014164777).

(i) variants exhibiting at least 85% identity with AmyE from Bacillus subtilis (SEQ ID NO:1 in WO2009149271).

(j) Variants exhibiting at least 90% identity variant with the wild-type amylase from Bacillus sp. KSM-K38 with accession number AB051102.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS®, POWERASE® and PURASTAR OXAM® (Genencor International Inc., Palo Alto, Calif.) and KAM® (Kao, 14-10 Nihonbashi Kayabacho, 1-chome, Chuo-ku Tokyo 103-8210, Japan). In one aspect, suitable amylases include NATALASE®, STAINZYME® and STAINZYME PLUS® and mixtures thereof.

Lipases. Preferably the composition comprises one or more lipases, including “first cycle lipases” such as those described in U.S. Pat. No. 6,939,702 B1 and US PA 2009/0217464. Preferred lipases are first-wash lipases. The composition may comprise a first wash lipase.

Enzyme Stabilizing System. The composition may optionally comprise from about 0.001% to about 10% by weight of the composition, of an enzyme stabilizing system. The enzyme stabilizing system can be any stabilizing system which is compatible with the detersive enzyme. In the case of aqueous detergent compositions comprising protease, a reversible protease inhibitor, such as a boron compound, including borate, 4-formyl phenylboronic acid, phenylboronic acid and derivatives thereof, or compounds such as calcium formate, sodium formate and 1,2-propane diol may be added to further improve stability.

Builder. The composition may optionally comprise a builder or a builder system. Built cleaning compositions typically comprise at least about 1% builder, based on the total weight of the composition. Liquid cleaning compositions may comprise up to about 10% builder, and in some examples up to about 8% builder, of the total weight of the composition. Granular cleaning compositions may comprise up to about 30% builder, and in some examples up to about 5% builder, by weight of the composition.

Builders selected from aluminosilicates (e.g., zeolite builders, such as zeolite A, zeolite P, and zeolite MAP) and silicates assist in controlling mineral hardness in wash water, especially calcium and/or magnesium, or to assist in the removal of particulate soils from surfaces. Suitable builders may be selected from the group consisting of phosphates, such as polyphosphates (e.g., sodium tri-polyphosphate), especially sodium salts thereof; carbonates, bicarbonates, sesquicarbonates, and carbonate minerals other than sodium carbonate or sesquicarbonate; organic mono-, di-, tri-, and tetracarboxylates, especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. These may be complemented by borates, e.g., for pH-buffering purposes, or by sulfates, especially sodium sulfate and any other fillers or carriers which may be important to the engineering of stable surfactant and/or builder-containing cleaning compositions. Additional suitable builders may be selected from citric acid, lactic acid, fatty acid, polycarboxylate builders, for example, copolymers of acrylic acid, copolymers of acrylic acid and maleic acid, and copolymers of acrylic acid and/or maleic acid, and other suitable ethylenic monomers with various types of additional functionalities. Also suitable for use as builders herein are synthesized crystalline ion exchange materials or hydrates thereof having chain structure and a composition represented by the following general anhydride form: x(M20).ySiO₂.zM′O wherein M is Na and/or K, M′ is Ca and/or Mg; y/x is 0.5 to 2.0; and z/x is 0.005 to 1.0.

Alternatively, the composition may be substantially free of builder.

Chelating Agent. The composition may also comprise one or more metal ion chelating agents. Suitable molecules include copper, iron and/or manganese chelating agents and mixtures thereof. Such chelating agents can be selected from the group consisting of phosphonates, amino carboxylates, amino phosphonates, succinates, polyfunctionally-substituted aromatic chelating agents, 2-pyridinol-N-oxide compounds, hydroxamic acids, carboxymethyl inulins, and mixtures therein. Chelating agents can be present in the acid or salt form including alkali metal, ammonium, and substituted ammonium salts thereof, and mixtures thereof.

Additional Amines: Additional amines may be used in the composition for added removal of grease and particulates from soiled materials. The compositions may comprise from about 0.1% to about 10%, in some examples, from about 0.1% to about 4%, and in other examples, from about 0.1% to about 2%, by weight of the cleaning composition, of additional amines. Non-limiting examples of additional amines may include, but are not limited to, polyamines, oligoamines, triamines, diamines, pentamines, tetraamines, or combinations thereof. Specific examples of suitable additional amines include tetraethylenepentamine, triethylenetetraamine, diethylenetriamine, or a mixture thereof.

Dye Transfer Inhibiting Agent. The composition can further comprise one or more dye transfer inhibiting agents. Suitable dye transfer inhibiting agents include, for example, polyvinylpyrrolidone polymers, polyamine N-oxide polymers, copolymers of N-vinylpyrrolidone and N-vinylimidazole, polyvinyloxazolidones, polyvinylimidazoles, manganese phthalocyanine, peroxidases, polyvinylpyrrolidone polymers, ethylene-diamine-tetraacetic acid (EDTA); diethylene triamine penta methylene phosphonic acid (DTPMP); hydroxy-ethane diphosphonic acid (HEDP); ethylenediamine N,N′-disuccinic acid (EDDS); methyl glycine diacetic acid (MGDA); diethylene triamine penta acetic acid (DTPA); propylene diamine tetraacetic acid (PDT A); 2-hydroxypyridine-N-oxide (HPNO); or methyl glycine diacetic acid (MGDA); glutamic acid N,N-diacetic acid (N,N-dicarboxymethyl glutamic acid tetrasodium salt (GLDA); nitrilotriacetic acid (NTA); 4,5-dihydroxy-m-benzenedisulfonic acid; citric acid and any salts thereof; N-hydroxyethylethylenediaminetri-acetic acid (HEDTA), triethylenetetraaminehexaacetic acid (TTHA), N-hydroxyethyliminodiacetic acid (HEIDA), dihydroxyethylglycine (DHEG), ethylenediaminetetrapropionic acid (EDTP) and derivatives thereof or a combination thereof.

Bleaching Compounds, Bleaching Agents, Bleach Activators, and Bleach Catalysts. The compositions described herein may comprise bleaching agents, bleach activators and/or bleach catalysts. Bleaching ingredients may be present at levels of from about 1% to about 30%, and in some examples from about 5% to about 20%, based on the total weight of the composition. If present, the amount of bleach activator may be from about 0.1% to about 60%, and in some examples from about 0.5% to about 40%, of the composition. When the composition is a laundry composition in powder form, the composition preferably comprises percarbonate bleach, and a bleach activator, preferably TAED. If the composition is a laundry composition in liquid form, it is preferred that the liquid composition is substantially free of bleaching compounds.

Examples of bleaching agents include oxygen bleach, perborate bleach, percarboxylic acid bleach and salts thereof, peroxygen bleach, persulfate bleach, percarbonate bleach, and mixtures thereof.

In some examples, compositions may also include a transition metal bleach catalyst.

Bleaching agents other than oxygen bleaching agents are also known in the art and can be utilized in composition. They include, for example, photoactivated bleaching agents, or pre-formed organic peracids, such as peroxycarboxylic acid or salt thereof, or a peroxysulphonic acid or salt thereof.

Brightener. Optical brighteners or other brightening or whitening agents may be incorporated at levels of from about 0.01% to about 1.2%, by weight of the composition.

Commercial brighteners, which may be used herein, can be classified into subgroups, which include, but are not necessarily limited to, derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

In some examples, the fluorescent brightener is selected from the group consisting of disodium 4,4′-bis{[4-anilino-6-morpholino-s-triazin-2-yl]-amino}-2,2′-stilbenedisulfonate (brightener 15, commercially available under the tradename Tinopal AMS-GX by Ciba Geigy Corporation), disodium4,4′-bis{[4-anilino-6-(N-2-bis-hydroxyethyl)-s-triazine-2-yl]-amino}-2,2′-stilbenedisulonate (commercially available under the tradename Tinopal UNPA-GX by Ciba-Geigy Corporation), disodium 4,4′-bis{[4-anilino-6-(N-2-hydroxyethyl-N-methylamino)-s-triazine-2-yl]-amino}-2,2′-stilbenedisulfonate (commercially available under the tradename Tinopal 5BM-GX by Ciba-Geigy Corporation). More preferably, the fluorescent brightener is disodium 4,4′-bis{[4-anilino-6-morpholino-s-triazin-2-yl]-amino}-2,2′-stilbenedisulfonate.

The brighteners may be added in particulate form or as a premix with a suitable solvent, for example nonionic surfactant, monoethanolamine, propane diol.

Fabric Hueing Agent. The composition may comprise a fabric hueing agent (sometimes referred to as shading, bluing or whitening agents). Typically, the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Encapsulate. The composition may comprise an encapsulate. The encapsulate may comprises a core, a shell having an inner and outer surface, where the shell encapsulates the core.

Other ingredients. The composition can further comprise silicates. Suitable silicates can include, for example, sodium silicates, sodium disilicate, sodium metasilicate, crystalline phyllosilicates or a combination thereof. In some embodiments, silicates can be present at a level of from about 1% to about 20% by weight, based on the total weight of the composition.

The composition can further comprise other conventional detergent ingredients such as foam boosters, suds suppressors, anti-corrosion agents, soil-suspending agents, anti-soil redeposition agents, dyes, bactericides, tarnish inhibiters, and/or optical brighteners.

The composition can optionally further include saturated or unsaturated fatty acids, preferably saturated or unsaturated C₁₂-C₂₄ fatty acids; deposition aids, for example, polysaccharides, cellulosic polymers, poly diallyl dimethyl ammonium halides (DADMAC), and co-polymers of DADMAC with vinyl pyrrolidone, acrylamides, imidazoles, imidazolinium halides, and mixtures thereof, in random or block configuration, cationic guar gum, cationic cellulose, cationic starch, cationic polyacrylamides or a combination thereof. If present, the fatty acids and/or the deposition aids can each be present at 0.1% to 10% by weight, based on the total weight of the composition.

The composition may optionally include silicone or fatty-acid based suds suppressors; hueing dyes, calcium and magnesium cations, visual signaling ingredients, anti-foam (0.001% to about 4.0% by weight, based on the total weight of the composition), and/or a structurant/thickener (0.01% to 5% by weight, based on the total weight of the composition) selected from the group consisting of diglycerides and triglycerides, ethylene glycol distearate, microcrystalline cellulose, microfiber cellulose, biopolymers, xanthan gum, gellan gum, and mixtures thereof).

### Additive Composition

The additive compositions of the present disclosure may include additional adjunct ingredients. Such adjuncts may provide additional treatment benefits to the target fabrics, and/or they may act as stabilization or processing aids to the compositions. Suitable adjuncts may include chelant, chlorine scavenger, malodor reduction materials, organic solvents, or mixtures thereof.

### Fabric Enhancer

The composition of the invention can be in the form of a fabric enhancer. The fabric enhancer for use herein comprises a fabric softening active. Suitable fabric softening actives, include, but are not limited to, materials selected from the group consisting of quats, amines, fatty esters, sucrose esters, silicones, dispersible polyolefins, clays, polysaccharides, fatty oils, polymer latexes and mixtures thereof. Preferably the fabric softening active is a quaternary ammonium compound, more preferably an ester quaternary ammonium compound, even more preferably a diester quaternary ammonium compound.

Typical minimum levels of incorporation of the fabric softening active in the fabric enhancer is at least about 1%, alternatively at least about 2%, alternatively at least about at least about 3%, alternatively at least about at least about 5%, alternatively at least about 10%, and alternatively at least about 12%, by weight of the fabric enhancer. The fabric enhancer may typically comprise maximum levels of fabric softening active of about less than about 90%, alternatively less than about 40%, alternatively less than about 30%, alternatively less than about 20%, by weight of the fabric enhancer.

### Method of Treating a Surface

The present disclosure relates to a method of treating a surface, the surface can be a hard surface or a soft surface, preferably the surface is a soft surface, more preferably the surface is a fabric.

For example, the method of the present disclosure may include contacting a fabric with a product according to the present disclosure. The contacting may occur in the presence of water, in its totality or partially. The product, or part thereof, may be diluted and/or dissolved in the water to form a treatment liquor.

The method of the present disclosure may include contacting a surface, preferably a fabric with an aqueous treatment liquor. The aqueous treatment liquor may comprise from about 1×10² Colony forming units (CFUs) to about 1×10⁸ CFU/liter of wash liquor, preferably from about 1×10⁴ CFUs to about 1×10⁷ CFU/liter of wash liquor of total bacterial spores, preferably Bacillus spores. The method of treating a fabric may take place in any suitable vessel, in its entirety or partially, for example it may take place in an automatic washing machine. Such machines may be top-loading machines or front-loading machines. The whole process can take place in a washing machine. Alternatively, part of the process can take place in a washing machine and part of the process can take place in a dryer. The process of the invention is also suitable for hand washing applications.

The treatment step may be part of a wash or a rinse cycle of an automatic washing machine. The aqueous treatment liquor may be an aqueous rinse liquor. A product according to the present disclosure may be added to the drawer or drum of an automatic washing machine during a wash or a rinse cycle.

The treatment step of the method of the present disclosure may include contacting the fabric with an aqueous wash liquor. The step of contacting the fabric with an aqueous wash liquor may occur prior to contacting the fabric with an aqueous rinse liquor. Such steps may occur during a single treatment cycle. The aqueous wash liquor may comprise a cleaning composition, such as a granular or liquid laundry detergent composition, that is dissolved or diluted in water. The detergent composition may include anionic surfactant. The aqueous wash liquor may comprise from about 50 to about 5000 ppm, or from about 100 to about 1000 ppm, anionic surfactant.

The bacterial spores, preferably Bacillus spores may be added from an additive composition in a level of from about 0.01% to about 5% by weight of the fabric. Preferably, the bacterial spores are provided as part of beads or a part of a dryer sheet.

The fabric treated may be a natural or a synthetic fabric. Suitable synthetic fabrics include polyester, acrylic, nylon, rayon, acetate, spandex, latex, and/or orlon fabrics. The composition and method of the invention provides very good malodor removal and/or prevention on synthetic fabric.

The fabric treated may include synthetic fibers. Suitable synthetic fibers may include polyester, acrylic, nylon, rayon, acetate, spandex, latex, and/or orlon fibers. The fibers may be elastic and/or contain elastane. The fabric may contain blends of synthetic fibers and natural fibers (e.g., a polycotton blend). The fabric may comprise fibers that are relatively hydrophobic (for example, compared to cotton fibers).

### Example

The following experiment was conducted to measure the impact of Bacillus spores on liberation of the perfume alcohol thymol from its glucoside. Knitted cotton swatches with thymol glucoside were treated with and without Bacillus spores. Thymol release was quantified using GC-MS.

Prior to testing, Knitted cotton swatches (GMT desized knitted cotton, Warwick Equest Ltd.) were autoclaved to sterilize for 20 mins at 121° C. 12 swatches were added to 12 20 mL GC-MS vials and infused with 0.5 mL thymol-b-D-glucopyranoside (product code: MT06890, Carbosynth) in ethanol (27% of weight) and left to dry overnight in fume hood. The swatches were then infused with 1 mL tryptic soy broth (product code: 22092, Sigma Aldrich) in water (3% of weight). Half of the samples were treated with 100 mL of a 4.18×10⁶ cfu/mL suspension of Bacillus spores blend in sterile water and the other half were treated with 100 uL sterile water. The Bacillus spores used were Evozyme® P500 BS7, Genesis Biosciences, Cardiff. Swatches were incubated in sealed GC-MS vials at 35° C. oven for 72 hours before being left for 96 hours at room temperature prior to analysis.

The headspace above the fabric was sampled and analysed using GC-MS. This involved incubating the samples at 65° C. for 10 minutes prior to sampling the headspace with a DVB/CAR/PDMS-SPME fibre (Divinylbenzene/Carboxen/Polydimethylsiloxane—Solid Phase Micro Extraction). The fibre was then desorbed in the hot inlet of the Agilent 7890B gas chromatograph. The thymol present in the headspace was separated from the other molecules on a DB-5 column and identified by Agilent 5977B mass-spectrometer.

The table below shows the average thymol mass-spec peak abundance in the head space for both treatments, together with the standard errors.

| Thymol mass-spec | With | Without |
|---|---|---|
| peak abundance | Bacillus spores | Bacillus spores |
| Mean | 58,307,807 | 8,163,790 |
| Standard error | 1,481,635 | 8,062,866 |

Results show that the presence of Bacillus spores increases release of thymol from thymol glucoside by over 7 times compared to the control. This result is statistically significant at 99% confidence level.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

What is claimed is:

1. A surface treatment composition comprising:
a) from about 1×10² to about 1×10⁹ CFU/g of the composition of Bacillus spores;
b) from about 0.01% to about 15% by weight of the composition of a pro-perfume comprising a glycoside, a phosphate acid ester, an amino-acid derivative, a carboxylic acid derivative, or a combination thereof; and
c) a perfume.

2. The composition according to claim 1, wherein the Bacillus comprises Bacillus subtilis, Bacillus amyloliquefaciens, Bacillus licheniformis, Bacillus megaterium, Bacillus pumilus, Bacillus cereus, Bacillus thuringiensis, Bacillus mycoides, Bacillus tequilensis, Bacillus vallismortis, Bacillus mojavensis, or a combination thereof.

3. The composition according to claim 1, wherein the Bacillus is selected from the group consisting of Bacillus subtilis, Bacillus amyloliquefaciens, Bacillus licheniformis, Bacillus megaterium, Bacillus pumilus, and mixtures thereof.

4. The composition according to claim 1, wherein the pro-perfume material comprises a glycoside.

5. The composition according to claim 4, wherein the pro-perfume material comprises an alkylglucoside.

6. The composition according to claim 1, where the glycoside comprises a β-D-glucoside.

7. The composition according to claim 1 wherein the composition is a cleaning composition comprising a surfactant system.

8. The composition according to claim 7 wherein the cleaning composition is a laundry cleaning composition comprising an enzyme.

9. The composition according to claim 1 wherein the composition is a hard surface cleaning composition.

10. The composition according to claim 1, wherein the composition comprises an adjunct comprising one or more of: peroxy compounds, bleach activators, anti-redeposition agents, neutralizers, optical brighteners, foam inhibitors, chelators, bittering agents, dye transfer inhibitors, soil release agents, water softeners, electrolytes, pH regulators, anti-graying agents, anti-crease components, bleach agents, colorants, scents, or processing aids.

11. The composition according to claim 1 wherein the composition is a laundry additive in the form of a bead or dryer sheet.

12. The composition according to claim 1 wherein the composition is a fabric enhancer comprising a conditioning agent.

13. The composition of claim 12, wherein the conditioning agent comprises a quaternary ammonium compound.

14. The composition of claim 13, wherein the conditioning agent comprises a diester quaternary ammonium compound.

15. A method of providing sustained freshness to a surface, the method comprising the step of treating the surface with a composition according to claim 1.
